(19) United States
(12) Patent Application Publication
(10) Pub. No.: US 2017/0127748 A1
(43) Pub. Date: May 11, 2017

(54) MULTILAYER ARTICLE WITH IMPROVED IMPACT RESISTANCE

(71) Applicant: ROGERS CORPORATION, Rogers, CT (US)

(72) Inventors: Murali Sethumadhavan, Acton, MA (US); David C. Sherman, Ashford, CT (US)

(21) Appl. No.: 15/340,049

(22) Filed: Nov. 1, 2016

Related U.S. Application Data
(60) Provisional application No. 62/251,362, filed on Nov. 5, 2015.

(51) Int. Cl. A42B 3/06; A42B 3/12; B32B 7/12; B32B 5/18; B32B 9/04

(52) U.S. Cl. CPC A42B 3/063; B32B 5/18; B32B 9/046; B32B 7/12; B32B 9/045; A42B 3/125; B32B 2307/72; B32B 2437/04

(57) ABSTRACT

A multilayer article that includes a first polymer foam layer; a second polymer foam layer; and a carbon layer located between the first polymer foam layer and the second polymer foam layer. An article, such as a helmet, can comprise the multilayer article.

### CROSS-REFERENCE TO RELATED APPLICATION

This application claims the benefit of U.S. Provisional Patent Application Ser. No. 62/251,362 filed Nov. 5, 2015. The related application is incorporated herein by reference in its entirety.

### BACKGROUND

Protective gear is worn by individuals to protect against injury. For example, the use of protective headgear or helmets is often a mandatory requirement for driving bicycles and certain other motor vehicles, in high impact sports, and in construction zones.

Commonly used protective headgear includes a hard outer casing with an impact-energy absorbing padding placed between the outer casing and the user's head. In general, an impact to the hard casing of the helmet generates a high-impact shock wave, which the shock absorbing material dissipates, to minimize its effects. In sports such as baseball or cricket, the helmet's primary purpose is to protect the head from the impact of a high velocity ball. In sports such as football, there has been an increasing use of the helmet as an initial contact point while tackling and blocking. The generation of such a high-impact shockwave from one or more of these occurrences can lead to a concussion (striking of the brain matter to the skull with moderate force) or even a contusion (striking of the brain matter to the skull with high force) and may also lead to skull fracture.

Hence, an improved shock absorbing material, for example, for use in protective gear is highly desirable to help to reduce the force of the impact experienced by the wearer of the protective gear.

### BRIEF SUMMARY

Disclosed herein is a multilayer article with improved impact resistance and a method of making and of using the same.

In an embodiment, a multilayer article comprises a first polymer foam layer; a second polymer foam layer; and a carbon layer located between the first polymer foam layer and the second polymer foam layer.

In another embodiment, an article, such as a helmet, can comprise the multilayer article.

The above described and other features are exemplified by the following figures and detailed description.

### BRIEF DESCRIPTION OF THE DRAWINGS

The following Figures are exemplary embodiments, wherein the like elements are numbered alike.

FIG. 1 is an illustration of an embodiment of a multilayer article; and

FIG. 2 is an illustration of an embodiment of a multilayer article comprising an adhesive layer.

### DETAILED DESCRIPTION

The inventors hereof surprisingly discovered that a multilayer article comprising a first polymer foam layer, a second polymer foam layer, and a carbon layer located in between the first polymer foam layer and the second polymer foam layer has increased impact strength compared to a solitary foam layer or carbon layer. For example, the multilayer article has an improved impact absorption of greater than or equal 15%, or greater than or equal to 25% relative to the same multilayer but without the carbon layer. The multilayer article can also have a similar compressive force deflection (CFD), for example, within 20% or within 10% of a CFD of the same multilayer but without the carbon layer. The multilayer article can be used, for example, in protective gear such as helmets. Compared to current helmet materials, the multilayer article would allow for thinner and lighter protection, and may be more comfortable because one of the foam layers could be in contact with the wearer's head.

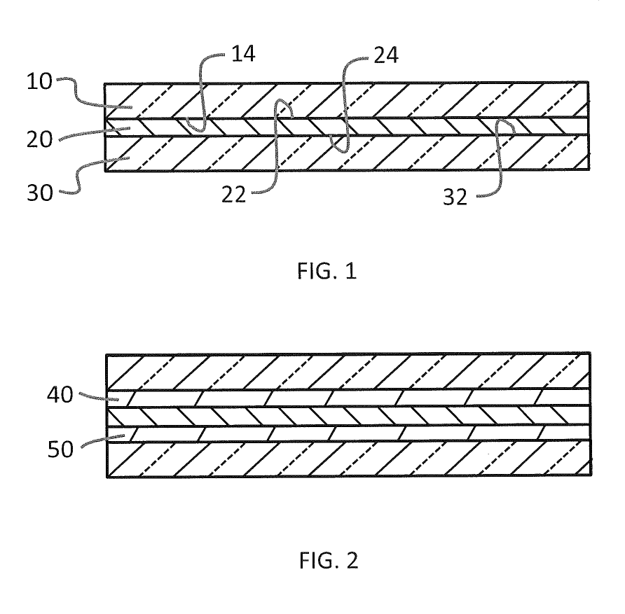

The multilayer article comprises a first polymer foam layer, a carbon layer, and a second polymer foam layer, for example, as illustrated in FIG. 1 and FIG. 2. FIG. 1 illustrates that first polymer foam layer inner surface 14 of first polymer foam layer 10 is in contact with carbon layer first side 22 of carbon layer 20, and that second polymer foam layer inner surface 32 of second polymer foam layer 30 is in contact with carbon layer second side 24 of the carbon layer 20. FIG. 2 illustrates that first adhesive layer 40 is located in between first polymer foam layer 10 and carbon layer 20, and that second adhesive layer 50 is located in between second polymer foam layer 30 and carbon layer 20.

The first polymer foam layer and the second polymer foam layer can each independently comprise a polymer foam. The first polymer foam layer and the second polymer foam layer can comprise the same foam. The first polymer foam layer and the second polymer foam layer can comprise a different foam. As used herein, “polymer foam” refers to a polymeric material having a cellular structure, where the cells can be open (reticulated) or closed. The properties of the foam (e.g., density, modulus, compression load deflection, tensile strength, tear strength, and so forth) can be adjusted by varying the components of the reactive compositions as is known in the art. The foams are compressible, i.e., soft, and can have densities of less than 65 pounds per cubic foot (pcf) (1,041 kilograms per cubic meter (kg/m³)), specifically, less than or equal to 55 pcf (881 kg/m³), more specifically, not more than 25 pcf (400 kg/m³), a void volume content of 20 to 99%, specifically, 30 to 80%, based upon the total volume of the polymeric foam. The foam can have a density of 5 to 30 pcf (80 to 481 kg/m³). The foam can have a 25% CFD of 0.5 to 20 pounds per inches squared (psi) (3.4 to 138 kilopascal (kPa)) as determined by ASTM-D 3574: PTP-0033 at 25% deflection. The foam can have a compression set at 70 degrees Fahrenheit (° F.) (21 degrees Celsius (° C.)) of less than 10%, specifically, less than 5% as determined in accordance with ASTM-D 3574 Test D. The foam is manufactured from a precursor composition that is mixed prior to or concomitant with foaming.

One or both of the first polymer foam layer and the second polymer foam layer can comprise a wide variety of polymer foams, including various thermoplastics or thermosetting resins. Examples of polymers and resins that can be foamed for use in a foam layer include polyacetals, polyacrylics, styrene-acrylonitrile (SAN), polyolefins, acrylonitrile-butadiene-styrene (ABS), polycarbonates, polystyrenes, polyesters such as polyethylene terephthalates and polybutylene terephthalates, polyamides such as Nylon 6, Nylon 6,6, Nylon 6,10, Nylon 6,12, Nylon 11 or Nylon 12, polyamideimides, polyarylates, polyurethanes, ethylene propylene rubbers (EPR), polyurethanes, epoxies, phenolics, silicones, and the like, or a combination comprising at least one of the foregoing.

In some embodiments the foam can comprise a polyurethane or a silicone foam. Open celled, low modulus polyurethane foams are preferred, based on their favorable compression force, deflection, compression set, as well as their good wear properties. The polyurethane foam can have an average cell size of 50 to 250 micrometers (μm) (as can be measured in accordance with ASTM D 3574-95); a density of between about 5 to 30 pcf, specifically, 6 to 25 pcf; a compression set at 70° F. (21 degrees Celsius (° C.)) of less than about 10% as determined in accordance with ASTM-D 3574 Test D; and a 25% compression force deflection of 1 to 9 psi (7 to 63 kPa) as determined by ASTM-D 3574: PTP-0033 at 25% deflection. Such materials are marketed, for example, under the trade name PORON by the Rogers Corporation, Woodstock, Conn. PORON foams have been formulated to provide an excellent range of properties, including excellent compression set resistance. Foams with such compression set resistance can provide cushioning and maintain their original shape or thickness under loads for extended periods of time. The foam can comprise a PORON XRD™ high impact foam. The foam can comprise a PORON CFD high impact foam.

The first polymer foam layer and the second polymer foam layer can each independently have a thickness of 0.1 to 10 millimeters (mm), specifically, 0.3 to 5 mm.

The carbon layer can comprise a graphene sheet, a carbon fiber mat, a carbon nanotube mat, or a combination comprising at least one of the foregoing. The carbon layer can have a thickness of 0.3 nm to 2 mm.

As used herein the term “graphene sheet” refers to one or more layers of aromatic polycyclic carbon atoms that are covalently bound to each other by sp2 bonds. The carbon atoms can be bound together to form a hexagonal array. The graphene sheet can comprise one or more layers of graphene sheets, for example, 1 to 100, or 1 to 50, or 5 to 10 graphene sheets. The graphene sheet can have one or both of a high tensile strength (for example, 100 to 200 gigapascal (GPa)) and high mechanical modulus (for example, a Young's modulus of greater than or equal to 0.5 terapascal (TPa), or 0.5 to 1.5 TPa. The graphene sheet can have a thickness of 0.3 to 100 nanometers (nm), or 1 to 50 nm, or 2 to 10 nm.

The graphene sheet can be formed by solvent casting (for example, from a solution comprising one or both of graphite and graphene, water, and optionally ammonia), chemical vapor deposition (CVD) onto a metal (i.e., foil) substrate, chemical exfoliation, mechanical exfoliation of graphite, epitaxial growth, or carbon nanotube cutting and direct sonication.

The solvent casting can comprise first preparing a graphite oxide by adding one or both of graphite and graphene to water; oxidizing the one or both of graphite and graphene; adding an agent such as potassium permanganate; neutralizing the agent with a neutralizing agent such as hydrogen peroxide; and recovering the graphite oxide. The graphite oxide can have an average particle size of 1 to 60, or 10 to 60 micrometers. A graphite oxide solution comprising 0.1 to 100 milligrams per milliliter (mg/ml) of the graphite oxide and 0.1 to 0.5 grams per liter (g/L) of ammonia can then be prepared, applied (for example, by drop casting, spray drying, or spin coating) to a steel substrate (such as a steel alloy comprising nickel and chromium and that has a spheroidized carbon structure), and dried. The drying can occur at 20 to 35° C. for 5 to 32 hours. The drying can comprise applying a multi-frequency infrared radiation in a vacuum (for example, 3 kPa to 100 MPa), or in nitrogen gas, for example, by applying far, medium, and short infrared frequencies with power in the range of 500 to 1,000 watts for 50 to 500 nanoseconds (ns). A bias voltage can be applied to the graphene sheets to control the growth of the graphene sheet. The direction of the bias voltage can be varied. A positive or negative bias can be applied to the sheet by the use of comb electrodes. The bias voltage can be 100,000 to 2,000,000 kilovolts (kV) at 0.001 ampere (A).

The carbon layer can comprise a plurality of carbon fibers. The carbon fibers can be formed by a variety of different methods. For example, the carbon fibers can be formed by carbonizing a polymer mat or they can be vapor grown fibers.

The carbon fibers can be formed by carbonizing a polymer mat comprising a plurality of polymer fibers, for example, pitch fibers, sulfonated polyolefin fibers, rayon fibers, phenolic fibers, polyacrylonitrile (PAN) fibers, or a combination comprising at least one of the foregoing. The polyolefin fibers can comprise polyethylene (such as linear low density polyethylene, low density polyethylene, high density polyethylene, ultrahigh molecular weight polyethylene), polypropylene, and polybutylene, specifically, linear low density polyethylene. As used herein, the term “sulfonated” is meant to be inclusive of sulfonation and any other type of sulfuration that can occur on the surface of polyolefin fibers during a sulfonation process, for example, sulfation, chloro-sulfonation, sulfoxidation, as well as the production of sulfonic acid groups and esters thereof. The polymer fibers can be prepared by melt spinning, electrospinning, or melt blowing. The polymer mat can be prepared by a slurry method and the polymer fibers can be chemically or physically bonded prior to the carbonization. The carbonization can comprise heating the plurality of polymer fiber precursors to a temperature of 300 to 3,200° C. for 0.02 to 12 hours in an inert atmosphere. The carbon fibers can have an average diameter of 0.05 to 100 micrometers. The carbon fibers can comprise amorphous carbon, graphitic carbon, crystalline carbon, semi-crystalline carbon, or a combination comprising at least one of the foregoing. The carbon fibers can be hollow or solid, and can be porous or non-porous.

The carbon fibers can comprise vapor grown carbon fibers. The vapor grown carbon fibers can be prepared by first providing a substrate with a catalyst on its surface; and heating the substrate to a first temperature of 400 to 900° C. for 15 to 90 minutes in the presence of hydrogen, ammonia, or a combination comprising at least one of the foregoing to provide nucleation points. The nucleation points can have a nucleation point density of 1 to 50 sites per meter squared (sites/m²) and an average nucleation point diameter of 10 to 2,000 nanometers (nm). A carbon-containing compound can then be introduced and the temperature can be adjusted to 600 to 1,200° C. for 1 to 3 hours to crack the carbon-containing compound and to form the carbon fibers. The carbon-containing compound can comprise methane, ethane, propane, butane, pentane, hexane, ethene, ethyne, benzene, methanol, ethanol, propanol, formic acid, acetic acid, propionic acid, natural gas, petroleum, or a combination comprising at least one of the foregoing.

The carbon layer can be formed from a plurality of carbon fibers by a slurry method. The slurry method can comprise mixing an aqueous slurry comprising the carbon fibers and 1 to 10 weight percent (wt %) binder fibers based on the weight of the slurry. The binder fibers can comprise a plurality of non-adhesive thermoplastic multi-component fibers (for example, comprising polyester, polypropylene, polysulfide, polyolefin, polyethylene fibers, or a combination comprising at least one of the foregoing). The slurry can then be deposited onto a porous forming surface and the aqueous solvent can be removed through the pores. After the aqueous solvent is removed, the binder fibers can be activated to form a melt attachment to the carbon fibers and to form the carbon fiber mat. The carbon fiber mat can then be dried.

The carbon fiber mat can be formed by extruding an extrudable mixture comprising a plurality of carbon fibers. The extrudable mixture can be an extrusion aid (such as an organic binder such as hydroxypropyl methyl cellulose). The extrudable mixture can comprise a glass particle, an oxide-based ceramic particle, a clay (such as kaolin and bentonite), a metallic particle (such as titanium, silicon, and nickel), or a combination comprising at least one of the foregoing.

The thickness of the carbon fiber mat can be 0.05 micrometers to 2 mm.

The multilayer article can comprise one or more adhesive layers, for example, the multilayer article can comprise one or both of a first adhesive layer located in between the first polymer foam layer and the carbon layer, and a second adhesive layer located in between the second polymer foam layer and the carbon layer. The first adhesive layer and the second adhesive layer can each independently comprise an adhesive such as a pressure sensitive adhesive. The adhesive can comprise a natural rubber, a polyolefin, a silicone, an acrylate polymer (such as polymethacrylate and polymethylmethacrylate), or a combination comprising at least one of the foregoing. The adhesive can comprise a synthetic rubber adhesive such as a combination comprising at least one of a polyisoprene, a polybutadiene, or a copolymer comprising at least one of the foregoing (such as a styrene-isoprene-styrene copolymer, a styrene-ethylene-butylene-styrene copolymer, and a styrene-butadiene-styrene copolymer). The adhesive can comprise a copolymer of isooctylacrylate and acrylic acid. The adhesive can comprise a methacrylate copolymer. The adhesive can comprise a combination comprising at least one of the foregoing adhesives.

The first adhesive layer and the second adhesive layer can each independently be 0.015 to 1 mm, specifically, 0.025 to 0.5 mm thick.

The first adhesive layer and the second adhesive layer can each independently comprise a tackifier. Examples of tackifiers include partially or fully hydrogenated resins such as C₉ and C₅ hydrocarbons such as those sold under the trade designation REGALITE™ REGALREZ™, PICCOTAC™, EASTOTAC™ commercially available from Eastman Chemical Co., ARKON™ commercially available from Arakawa Chemical Inc., Chicago, Ill.; and ESCOREZ′ commercially available from Exxon Mobil Corp., Irving, Tex.

The multilayer article can be prepared via a lamination method, in a roll-to-roll process, or via a combination comprising at least one of the foregoing. For example, the multi-step preparation method can comprise a first layering step comprising disposing the carbon layer on the first polymer foam layer inner surface such that the carbon layer first surface is in direct contact with the first polymer foam layer inner surface or such that a first adhesive layer is located therebetween; and a second layering step comprising disposing the second polymer foam layer on the carbon layer second surface such that the carbon layer second surface is in direct contact with the second polymer foam layer inner surface or such that a second adhesive layer is located therebetween. One or both of the first layering step and the second layering step can be performed via a roll-to-roll process. If the carbon layer is located on a support layer, the support layer can be removed, for example, via an etching step, during the roll-to-roll process.

The multilayer article can be formed by various methods. For example, the first polymer foam layer can be cast onto a first side of the carbon layer, followed by casting the second polymer foam layer onto a second side of the carbon layer. The multilayer article can be formed by simultaneously casting the first and second polymer foam layers on the first and second side of the carbon layer. The multilayer article can be formed by laminating the first and second polymer foam layers onto the carbon layer in one or two laminating steps.

The multilayer article can be used in protective gear such as helmets (such as football helmets, motorcycle helmets, bicycle helmets, hard hats, police helmets, firefighter helmets, martial arts helmets, hockey helmets, skating helmets (e.g., helmets for skateboarding, roller skating, or inline skating), snowboarding/skiing helmets, and baseball helmets), headgear (such as wrestling headgear and boxing headgear), chin straps, knee pads, elbow pads, wrist guards, shin guards, chest pads, back protectors, and the like. The multilayer article can be used in protective gear such as padded shirts, padded pants (such as padded shorts, and the like). The multilayer article can be used in foot wear. The multilayer article can be used in electronic devices (such as smart phones, tablets, and lap top computers).

The above multilayer article, method of making and uses thereof are further described in the below embodiments.

### Embodiment 1

A multilayer article comprising: a first polymer foam layer; a second polymer foam layer; and a carbon layer located between the first polymer foam layer and the second polymer foam layer.

### Embodiment 2

The multilayer article of Embodiment 1, wherein the first polymer foam layer and the second polymer foam layer each independently comprise a polyurethane or a silicone foam.

### Embodiment 3

The multilayer article of any one of the preceding embodiments, wherein the carbon layer comprises a graphene layer, a plurality of carbon fibers, a plurality of carbon nanotubes, or a combination comprising at least one of the foregoing.

### Embodiment 4

The multilayer article of any one of the preceding embodiments, wherein the first polymer foam layer and the second polymer foam layer are each independently 0.1 to 10 mm thick.

### Embodiment 5

The multilayer article of any one of the preceding embodiments, wherein the first polymer foam layer and the second polymer foam layer each independently have at least one of

a density of less than 1,041 kg/m³;

a void volume content of 20 to 99%, specifically, 30 to 80%, based upon the total volume of the polymeric foam;

a CFD of 0.3 to 1.41 kg/m² as determined by ASTM-D 3574: PTP-0033 at 25% deflection; and

a compression set at 21° C. of less than 10%, specifically, less than 5% as determined in accordance with ASTM-D 3574 Test D.

### Embodiment 6

The multilayer article of any one of the preceding embodiments, wherein the carbon layer has a thickness of 0.3 nm to 2 mm.

### Embodiment 7

The multilayer article of any one of the preceding embodiments, further comprising one or both of a first adhesive layer located in between the first polymer foam layer and the carbon layer, and a second adhesive layer located in between the second polymer foam layer and the carbon layer.

### Embodiment 8

The multilayer article of Embodiment 7, wherein the first adhesive layer and the second adhesive layer can each independently comprise a natural rubber, a polyolefin, a silicone, a methacrylate polymer, a polyisoprene, a polybutadiene, a polyacrylic acid, or a combination comprising at least one of the foregoing.

### Embodiment 9

The multilayer article of any one of Embodiments 7-8, wherein the first adhesive layer and the second adhesive layer can each independently have a thickness of 0.015 to 1 mm.

### Embodiment 10

The multilayer article of any one of Embodiments 7-9, wherein the first adhesive layer and the second adhesive layer can each independently comprise a tackifier.

### Embodiment 11

The multilayer article of any one of the preceding embodiments, wherein the multilayer article has a compressive force deflection of greater than or equal to 1.5 kg/m² as determined by ASTM-D 3574: PTP-0033 at 25% deflection.

### Embodiment 12

An article comprising the multilayer article of any one of the preceding embodiments.

### Embodiment 13

The article of Embodiment 12, wherein the article is a protective gear, for example, a helmet.

In general, this disclosure can alternately comprise, consist of, or consist essentially of, any appropriate components herein disclosed. This disclosure can additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All ranges disclosed herein are inclusive of the endpoints, and the endpoints are independently combinable with each other (e.g., ranges of “up to 25 wt %, or, more specifically, 5 to 20 wt %”, is inclusive of the endpoints and all intermediate values of the ranges of “5 to 25 wt %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this disclosure belongs. Unless otherwise stated, test standards are the most recent as of the filing date of the priority application.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

In addition, it is to be understood that the described elements can be combined in any suitable manner in the various embodiments.

While particular embodiments have been described, alternatives, modifications, variations, improvements, and substantial equivalents that are or can be presently unforeseen can arise to Applicants or others skilled in the art. Accordingly, the appended claims as filed and as they can be amended are intended to embrace all such alternatives, modifications variations, improvements, and substantial equivalents.

I/we claim:

1. A multilayer article comprising
a first polymer foam layer;
a second polymer foam layer; and
a carbon layer located between the first polymer foam layer and the second polymer foam layer.

2. The multilayer article of claim 1, wherein the first polymer foam layer and the second polymer foam layer each independently comprise a polyurethane or a silicone foam.

3. The multilayer article of claim 1, wherein the carbon layer comprises a graphene layer, a plurality of carbon fibers, a plurality of carbon nanotubes, or a combination comprising at least one of the foregoing.

4. The multilayer article of claim 1, wherein the first polymer foam layer and the second polymer foam layer are each independently 0.1 to 10 mm thick.

5. The multilayer article of claim 1, wherein the first polymer foam layer and the second polymer foam layer each independently have at least one of
a density of less than 1,041 kg/m³;
a void volume content of 20 to 99%, specifically, 30 to 80%, based upon the total volume of the polymeric foam;
a compression force deflection of 0.3 to 1.41 kg/m² as determined by ASTM-D 3574: PTP-0033 at 25% deflection; and
a compression set at 21° C. of less than 10%, specifically, less than 5% as determined in accordance with ASTM-D 3574 Test D.

6. The multilayer article of claim 1, wherein the carbon layer has a thickness of 0.3 nm to 2 mm.

7. The multilayer article of claim 1, further comprising one or both of a first adhesive layer located in between the first polymer foam layer and the carbon layer, and a second adhesive layer located in between the second polymer foam layer and the carbon layer.

8. The multilayer article of claim 7, wherein the first adhesive layer and the second adhesive layer can each independently comprise a natural rubber, a polyolefin, a silicone, a methacrylate polymer, a polyisoprene, a polybutadiene, a polyacrylic acid, or a combination comprising at least one of the foregoing.

9. The multilayer article of claim 7, wherein the first adhesive layer and the second adhesive layer can each independently have a thickness of 0.015 to 1 mm.

10. The multilayer article of claim 7, wherein the first adhesive layer and the second adhesive layer can each independently comprise a tackifier.

11. The multilayer article of claim 1, wherein the multilayer article has a compressive force deflection of greater than or equal to 1.5 kg/m² as determined by ASTM-D 3574: PTP-0033 at 25% deflection.

12. An article comprising the multilayer article of claim 1.

13. The article of claim 12, wherein the article is a protective gear, for example, a helmet.

14. The article of claim 13, wherein the protective gear is a helmet.
